(19) United States
(12) Patent Application Publication
(10) Pub. No.: US 2015/0042581 A1
(43) Pub. Date: Feb. 12, 2015

(54) Apparatus Having a Touch Screen Display

(71) Applicant: Joakim Söderberg, Solna (SE)

(72) Inventor: Joakim Söderberg, Solna (SE)

(73) Assignee: TELEFONAKTIEBOLAGET L M ERICSSON (PUBL), Stockholm (SE)

(21) Appl. No.: 14/375,326

(22) PCT Filed: Jan. 30, 2012
(86) PCT No.: PCT/EP2012/051448

§ 371 Date: Jul. 29, 2014

(51) Int. Cl. G06F 3/041

(52) U.S. Cl. CPC G06F 3/041; G06F 2203/04108
USPC 345/173

(57) ABSTRACT

An apparatus 100 having a touch screen display 110 is disclosed. The apparatus 100 comprises a touch Apparatus screen display 110 configured to display a content object. The apparatus 100 also comprises a processor 120 as well as a memory 130 storing a computer program comprising computer program code. When the computer program code is run in the processor, this causes the apparatus 100 to detect a non-trigger touch interaction with the touch screen display 110, and to identify the non-trigger touch interaction as comprising a hovering interaction over a content object displayed on the touch screen display 110. In response to the identification of the non-trigger touch interaction comprising a hovering interaction, an Uniform Resource Locator, URL, address associated with the displayed content object is displayed on the touch screen display 110. Corresponding methods, computer programs and computer program products are also disclosed herein.

### TECHNICAL FIELD

Embodiments of the present invention presented herein generally relate to user interface technology. More specifically, embodiments of the present invention relate to methods, apparatuses, computer programs and computer program products for facilitating interaction with apparatuses comprising a touch screen.

### BACKGROUND

Modern communication technology and modern computing technology has led to a new generation of apparatuses. Some apparatuses that are ubiquitous today have a small form factor and are used for execution of a wide range of applications. Examples of such apparatuses are portable electronic devices. Portable electronic devices include, but are not limited to, mobile telephones (sometimes also referred to as mobile phones, cell phones, cellular telephones, smart phones and the like) and tablet computers.

Traditionally, various user interfaces including for example mouse pointers, left and right mouse buttons, scroll wheels, keyboard scroll keys etc. were used to provide a way for users to interact with the apparatuses. However, as apparatuses become more compact, and the number of functions performed by a given apparatus increases, it has become a challenge to design a user interface that allows users to easily interact with a multifunction apparatus. This challenge is especially significant for handheld portable electronic devices, which generally have comparatively smaller displays or screens than e.g. desktop or laptop computers. The form factor together with a more advanced computing technology has therefore given rise to new apparatuses for allowing user interaction. One such apparatus that is becoming increasingly popular is the touch screen apparatus, i.e. an apparatus comprising a touch screen display. Touch screen displays allow users to interact with and send commands to an apparatus by touching an input object to the surface of the touch screen display.

Touch screen displays are attractive, e.g., because they facilitate small form factor apparatuses (e.g. mobile telephones or tablet computers) on which there may be limited room to include a display as well a one or several key buttons, scroll wheels, and/or the like for allowing the user to interact with and send commands to an apparatus. Also, inputting commands to an apparatus by touching a graphical user interface displayed on a touch screen display may be very intuitive to some users, and thus touch screen displays are generally perceived as user-friendly by many users.

### SUMMARY

It is in view of the above considerations and others that the various embodiments of the present invention have been made. The inventor has realized that, even if touch screens of today are generally perceived as providing effective and user-friendly interaction experiences, there is still a need for further improving or facilitating the interaction with apparatuses having a touch screen, i.e. touch screen apparatuses. Especially when navigating or browsing web pages by means of touch screen apparatuses, the inventor has realized that there exist rooms for improvement.

In view of the above, it is therefore a general object of the various embodiments of the present invention to facilitate the interaction with an apparatus comprising a touch screen display.

The various embodiments of the present invention as set forth in the appended claims address this general object.

According to a first aspect, there is provided an apparatus, e.g. a touch screen apparatus. The apparatus comprises a touch screen display configured to display a content object, wherein the content object is associated with a uniform resource locator, URL, address. The apparatus also comprises a processor and a memory storing a computer program comprising computer program code which, when run in the processor, causes the apparatus to detect a non-trigger touch interaction with the touch screen display, identify the non-trigger touch interaction as comprising a hovering interaction over a content object displayed on the touch screen display, and in response thereto display the URL address associated with the displayed content object.

The memory and the computer program code may be configured to, with the processor, further cause the apparatus to display the URL address associated with the displayed content object during a time length, which coincides with the time length during which it is identified that the non-trigger touch interaction comprises the hovering interaction.

In a preferred embodiment, the memory and the computer program code are configured to, with the processor, further cause the apparatus to display the URL address associated with the displayed content object during a time length, which is pre-set by a timer or a timer function. The time length may, for example, be set to 15 seconds.

The above-mentioned content object may comprise a shortened uniform resource locator, URL, address. Alternatively, the content object may comprise a Quick Response, QR, code.

The apparatus may be a portable electronic device, such as a mobile telephone or a tablet computer.

According to a second aspect, there is provided a method performed by an apparatus, such as a portable electronic device (e.g., a mobile telephone or a tablet computer). The method comprises detecting a non-trigger touch interaction with a touch screen display. The method also comprises identifying the non-trigger touch interaction as comprising a hovering interaction over a content object displayed at the touch screen display, wherein content object is associated with a uniform resource locator, URL, address. Furthermore, in response to identifying the non-trigger touch interaction as comprising the hovering interaction over the content object, the method comprises displaying the URL address associated with the displayed content object.

The step of displaying may comprise displaying the URL address associated with the displayed content object during a time length, which coincides with the time length during which it is identified that the non-trigger touch interaction comprises the hovering interaction. In a preferred embodiment, the step of displaying may comprise displaying the URL address associated with the displayed content object during a time length, which is pre-set. If the time length is pre-set, the method may additionally comprise a step of setting a timer or a timer function.

The content object may comprise a shortened uniform resource locator, URL, address or a Quick Response, QR, code.

According to a third aspect, there is provided a computer program. The computer program comprises computer program code which, when run in a processor of an apparatus, causes the apparatus to detect a non-trigger touch interaction with a touch screen display of the apparatus; identify the non-trigger touch interaction as comprising a hovering interaction over a content object displayed at the touch screen display; and in response thereto display the URL address associated with the displayed content object. The apparatus may, for example, be a portable electronic device (e.g., a mobile telephone or a tablet computer).

The computer program may comprise computer program code which, when run in the processor of the apparatus, further causes the apparatus to display the URL address associated with the displayed content object during a time length, which coincides with the time length during which it is identified that the non-trigger touch interaction comprises the hovering interaction.

The computer program may in preferred embodiments comprise computer program code which, when run in the processor of the apparatus, further causes the apparatus to display the URL address associated with the displayed content object during a time length, which is pre-set. The time length may, for example, be set to 15 seconds.

The content object may comprise a shortened uniform resource locator, URL, address or a Quick Response, QR, code.

According to a fourth aspect, there is provided a computer program product. The computer program product may comprise computer program according to the third aspect and a computer readable means on which the computer program is stored.

Various aspects and embodiments of the present invention provide for facilitated interaction with apparatuses having touch screen displays. By displaying the URL address of a displayed content object while or when moving, or hovering, over the displayed content object, a user interacting with the apparatus will be informed about the underlying URL address of the content object before making a decision to follow, i.e. click (touch) the content object. In other words, the displayed URL address will tell the user interacting with the apparatus where the URL address leads. This may allow for improved security. Various aspects and embodiments of the present invention thus allow for facilitated, user-intuitive and yet effective navigation or browsing of web pages on apparatuses having touch screen displays.

### BRIEF DESCRIPTION OF THE DRAWINGS

These and other aspects, features and advantages of the invention will be apparent and elucidated from the following description of embodiments of the present invention, reference being made to the accompanying drawings, in which:

FIG. 1 is a schematic diagram illustrating some modules of an embodiment of an apparatus comprising a touch screen display;

FIG. 2 illustrates a series of touch interactions with content displayed by a touch screen display according to an example embodiment of the invention;

FIG. 3 illustrates a series of touch interactions with content displayed by a touch screen display according to another example embodiment of the invention;

FIG. 4 is a flow chart illustrating a method performed by an apparatus according to an embodiment of the invention; and

FIG. 5 schematically shows one example of a computer program product comprising computer readable means.

### DETAILED DESCRIPTION

The invention will now be described more fully hereinafter with reference to the accompanying drawings, in which certain embodiments of the invention are shown. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like numbers refer to like elements throughout the description.

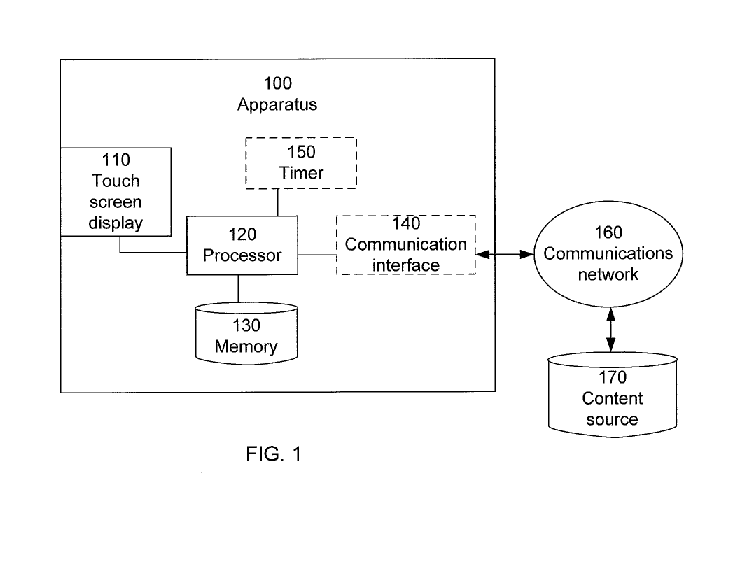

FIG. 1 illustrates a block diagram of an apparatus 100 according to an example embodiment of the present invention. The apparatus 100 may be embodied as any device comprising a touch screen display 110. Thus, the apparatus 100 may also be referred to as a touch screen apparatus. While FIG. 1 illustrates one example of a configuration of a touch screen apparatus, numerous other configurations may also be used to implement embodiments of the present invention.

The apparatus 100 may be embodied as a portable electronic device. Examples of portable electronic devices include, but are not limited to, mobile telephones (sometimes also referred to as mobile phones, cell phones, cellular telephones, smart phones and the like), mobile communication devices, tablet computers, etcetera.

The apparatus 100 illustrated in FIG. 1 comprises a touch screen display 110, a processor 120, and a memory 130. The apparatus may also comprise a communication interface 140. Thus, the apparatus 100 is operable to be in communication with a content source 170 over a communications network 160 via the communication interface 140. The communications network 160 may e.g. be complying with any or a combination of UMTS (Universal Mobile Telecommunications System), CDMA2000 (Code Division Multiple Access 2000), LTE (Long Term Evolution), GSM (Global System for Mobile Communications), WLAN (Wireless Local Area Network), etc. The content source 170 may comprise any device configured to interface with the apparatus 100 over the communication network 160 to send data to and/or receive data from the apparatus 100 over the communications network 160. In this regard, the content source 170 may, for example, comprise one or several servers or web servers. In this regard, the content source 170 may be configured to send data or content, such as, for example, application data, web page content, and/or the like to the apparatus 100 for display on the touch screen display 110 thereof. Yet further, the apparatus may optionally comprise a timer 150. In FIG. 1, there is illustrated a timer 150 embodied as a separate unit. It should however be appreciated that a timer function may be embodied as any device or means embodied in circuitry, hardware, a computer program product comprising computer readable program code stored on a computer readable medium (e.g., the memory 120) and executed by a processing device (e.g., the processor 120), or a combination thereof that is configured to provide the timer function. The touch screen display 110 may be in communication with the processor 120, memory 130, communication interface 140 and/or timer 150, such as via a bus.

The touch screen display 110 may comprise any known touch screen display that may be configured to enable touch recognition by any suitable technique, such as, for example, capacitive, resistive, infrared, strain gauge, surface wave, optical imaging, dispersive signal technology, acoustic pulse recognition, and/or other suitable touch recognition techniques. Accordingly, the touch screen display 110 may be operable to be in communication with the processor 120 to receive an indication of a user input in the form of a touch interaction, e.g., a contact between the touch screen display 110 and an input object (e.g., a finger, stylus, pen, pencil, and/or the like). It will be appreciated, that in some embodiments, the touch screen display 110 may include proximity sensing capabilities and in such embodiments, direct contact between the input object and surface of the touch screen display 110 may not be necessary. Accordingly, where an input object is described to be in contact with the surface of the touch screen display 110, it will be appreciated that “contact” may include direct contact as well as sufficient proximity for the touch screen display 110 to sense the input object. The touch screen display 110 may further be operable to be in communication with the processor 120 to provide an output, such as graphical output, to the user. This graphical output may comprise, for example, a graphical user interface, application data, document data, and/or the like to facilitate a user's use of and interaction with applications executed or otherwise implemented on the apparatus 100.

Throughout the present disclosure, it is referred to various touch interactions with the touch screen display 110. As used herein a non-trigger touch interaction is a touch interaction where a certain function is not performed. A non-trigger touch interaction may, for example, be a slide-in gesture performed by the input object on the touch screen display 110. The processor 120 may be configured to detect and/or identify a non-trigger touch interaction. However, since a non-trigger touch interaction is not associated with any function, the processor 120 will normally not trigger any function when detecting and/or identifying a non-trigger touch interaction. A hovering touch interaction, or simply hovering interaction, is one example of a non-trigger touch interaction. As used herein, a hovering interaction is used to mean when an input object is moved over (e.g., hovered over) a content object. Said content object may thus have a defined hover event associated therewith such that the processor 120 may be configured to detect and/or identify a non-trigger touch interaction as comprising the hovering interaction over the certain content object (displayed on the touch screen display 110). In other words, the term hover or hovering may be understood to mean a graphical user input (GUI) event where a user moves or “hovers” the input object (e.g. a finger) over a particular area of the touch screen display 110. Further, there exists trigger touch interactions. As used herein a trigger touch interaction is a touch interaction where a certain function is performed. To this end, the processor 120 may be configured to detect and/or identify a trigger touch interaction and in response thereto trigger a certain function. For example, a certain content object may have a pre-defined association with a certain function such that when the processor 120 detects a trigger touch interaction on a certain content object; this will cause processor to perform the certain function. One example is where a user performs the trigger touch interaction of clicking (touching) a displayed URL address on the touch screen display 110. This may trigger the function of loading the web page associated with the displayed URL address into the web browser.

The processor 120 may be provided using any suitable central processing unit (CPU), microcontroller, digital signal processor (DSP), etc., capable of executing computer program comprising computer program code, the computer program being stored in the memory 130. The memory 130 may be any combination of random access memory (RAM) and read only memory (ROM). The memory may also comprise persistent storage, which, for example, can be any single one or combination of magnetic memory, optical memory, or solid state memory or even remotely mounted memory.

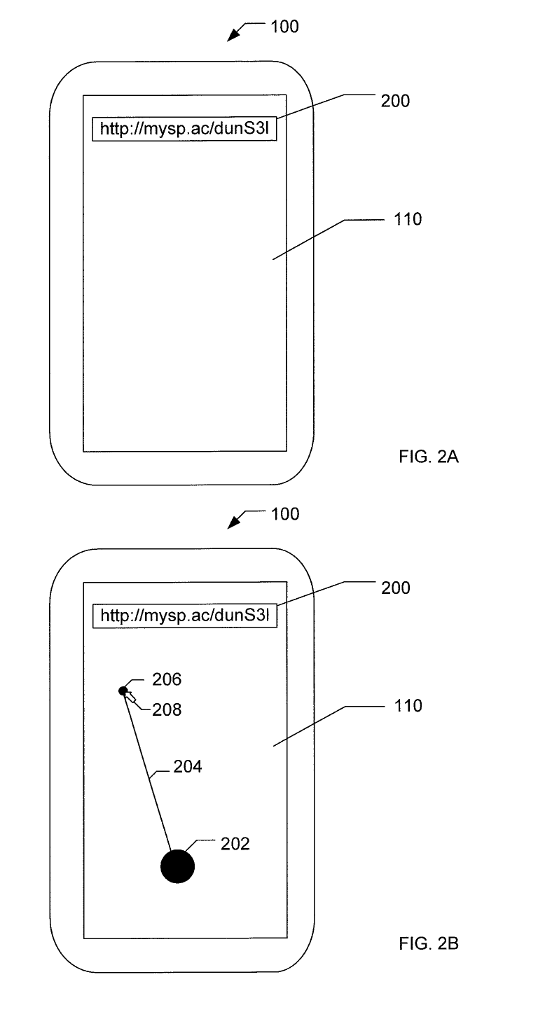

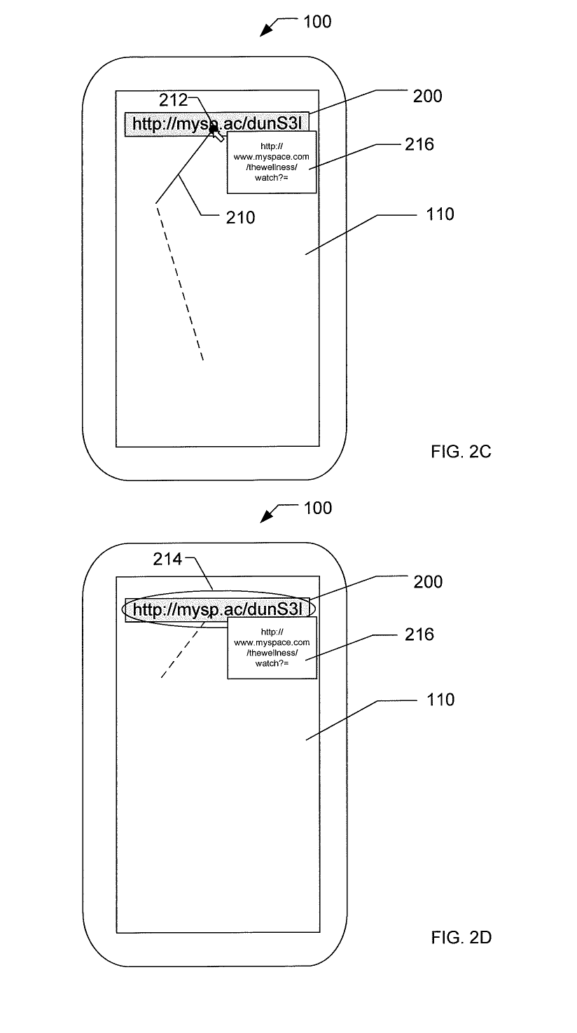

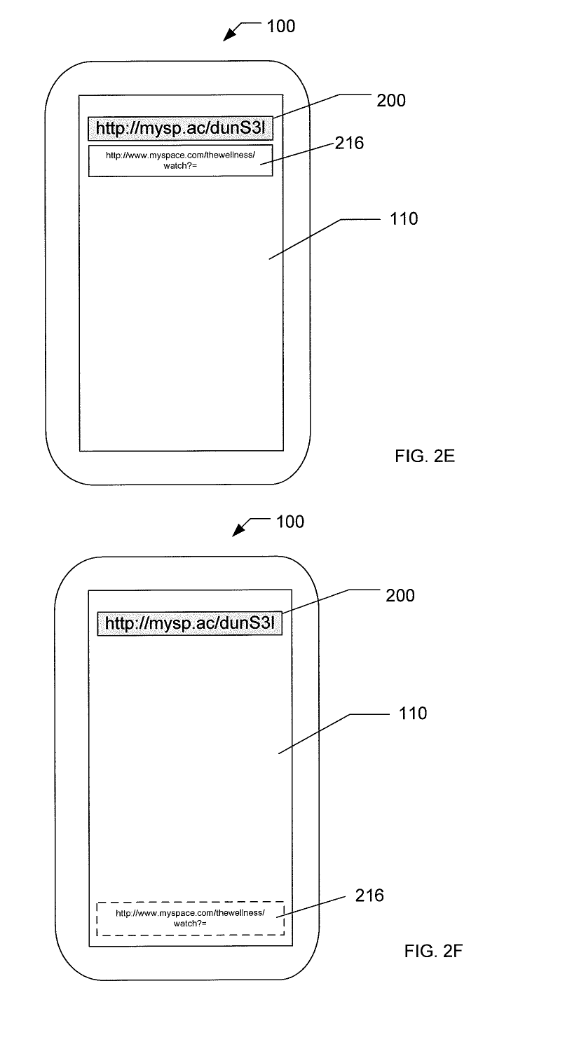

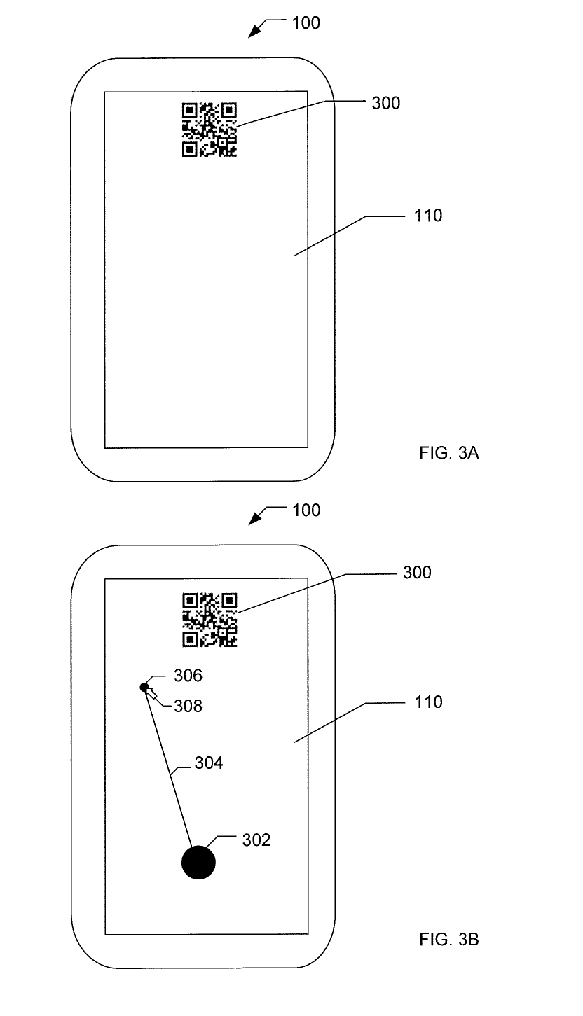

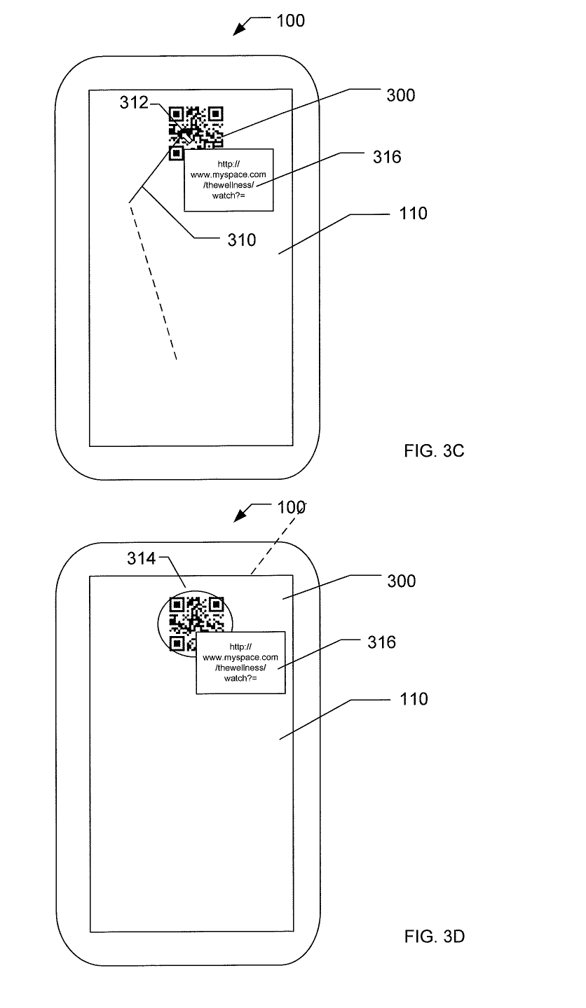

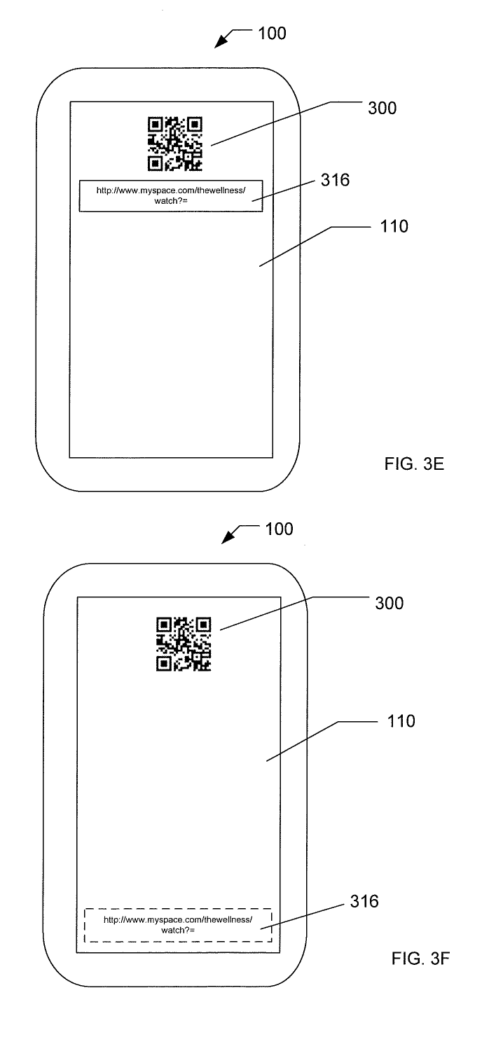

Embodiments of the present invention will now be exemplified and discussed in connection with FIGS. 2A-2F and 3A-3F, respectively, in conjunction with FIG. 1. As will be further detailed below, the touch screen display 110 of the apparatus 100 is configured to display a content object, the content object being associated with a uniform resource locator, URL, address. The memory 130 (see FIG. 1) stores computer program comprising computer program code which, when run in the processor 120 (see FIG. 1), causes the apparatus 100 to detect a non-trigger touch interaction with the touch screen display 110, identify the non-trigger touch interaction as comprising a hovering interaction over a content object displayed on the touch screen display 110, and in response thereto display the URL address associated with the displayed content object. In some embodiments, the URL address associated with the displayed content object is displayed during a time length, which coincides with the time length during which it is identified that the non-trigger touch interaction comprises the hovering interaction. In yet other embodiments, the URL address associated with the displayed content object is displayed during a time length, which is pre-set by a timer or a timer function.

In an example embodiment, the processor 120 is configured to communicate with the touch screen display 110 to receive indications of various touch interactions with the touch screen display 110, e.g. the above-mentioned non-trigger touch interactions, hovering interactions and trigger touch interactions.

FIGS. 2A-2F illustrate a series of touch interactions with a content object 200 that may be displayed by a touch screen display 110 of apparatus 100 according to an example embodiment of the invention. In this example, the apparatus 100 comprises a communication interface 140. Thus, the apparatus 100 is operable to be in communication with a content source 170 over a communications network 160 via the communication interface 140. Again, the content 170 source may comprise any device configured to interface with the apparatus 100 over the communication network 160 to send data to and/or receive data from the apparatus 100 over the communications network 160. In this regard, the content source 170 may comprise one or several servers or web servers. In this regard, the content source 170 may be configured to send data or content, such as, for example, application data, web page content, and/or the like to the apparatus 100 for display on the touch screen display 110 thereof.

In this illustrative example, the content object 200 is a shortened uniform resource locator (URL) address. URL shortening is a technique used on the World Wide Web, where a Uniform Resource Locator (URL) address may be made substantially shorter in length and still direct a user interacting with the apparatus 100 to the required web page. As is commonly known, the World Wide Web, is a system of interlinked hypertext documents accessed via the Internet. With a web browser, a user can view web pages that may contain text, images, videos, and other multimedia and navigate between them via hyperlinks. URL shortening can generally be achieved by using an HTTP Redirect or the like on a domain name that is short, which then links to the web page that has a long URL. HTTP Redirect, or URL redirection, are techniques on the World Wide Web for making a web page available under many URLs. For example, the URL address http://www.myspace.com/thewellness/watch?=could be shortened to http://mysp.ac/dunS31, as is shown in FIG. 2. URL shortening is especially convenient and interesting for messaging and/or blogging applications, which normally limit the number of characters that may be used in a message. Short URLs allow otherwise long web addresses to be referred to in messages when using messaging applications.

Referring now to FIG. 2B, a user has provided a non-trigger touch interaction by sliding an input object, such as a finger, along a path 204 from a point of origin 202 to a point 206 within the active region of the touch screen display 110. Optionally, a cursor 208 may be located at a present cursor location as determined by a location at which the input object is contacting the touch screen display 110. In FIG. 2B, the cursor 208 is displayed at the point 206, as the input object is still in contact with the touch screen display 110 at this point 206.

As can be seen in FIG. 2C, the user may provide a further non-trigger touch inter action comprising moving the input object along path 210 to the point 212, which is within the area of content object 200 (i.e. in this example the shortened URL address) displayed on the touch screen display 110. This non-touch touch interaction can be indentified as comprising an interaction at the point 212 overlying the shortened URL address 200. Or said differently, the non-trigger touch interaction can be identified as comprising a hovering interaction over the shortened URL address 200. To this end, the content object 200 may be a dynamic object having or otherwise being associated with a defined hover event. As will detailed below, the content object 200 may have a defined hover event such that a content object 216 is displayed in response to an input object being positioned over the content object 200 (e.g. hovering over the content object 200) In response to a non-trigger touch interaction comprising a hover interaction over the shortened URL address 200, a comparatively longer URL address 216 associated with the shortened URL address 200 can be displayed on the touch screen display 110. The comparatively longer URL address 216 is typically a full or complete URL address associated with the shortened URL address 200. In some embodiments, the URL address 216 associated with the displayed shortened URL address 200 is displayed during a time length, which coincides with the time length during which it is identified that the non-trigger touch interaction comprises the hovering interaction. In other words, as long as the user moves or hovers over the area 214 (see FIG. 2D), the URL address 216 will appear as a displayed content object on the touch screen display 110. Accordingly, the time length during which the URL address 216 is displayed is made dependent on the user's hovering interaction over the content object 200. In other embodiments, the URL address 216 associated with the displayed shortened URL address 200 is displayed during a pre-defined time length. The predefined time length may be pre-set by a timer of timer function of the apparatus 100. In a preferred embodiment, the time length may be pre-set to be 15 seconds. Thus, the content object 216 is only displayed temporarily. However, it will be appreciated that other time lengths are equally possible, such as 1, 2, 5, 10, 20, 30, 60 or 90 seconds. The exact time length can thus be pre-set to match different preferences of different users.

As will be appreciated, there are numerous ways of displaying the content object 216. One example is shown in FIGS. 2C-2D. In this example, the content object 216 is displayed to be partly overlapping the displayed content object 200. In FIG. 2E, the content object 216 is displayed in proximity to the content object 200, but not in any overlapping manner. In a third example, the content object 216 is displayed at a different portion of the touch screen display 110, e.g. at the side of the touch screen display 110, which is opposite to the side where the content object 200 is displayed. The content object 216, i.e. the longer URL address, may further be configured to change in appearance during the time length when it is displayed. For example, it may be configured to be displayed in a blinking manner. Alternatively, it may be configured to be displayed with varied light intensity such that, e.g., the light intensity is reduced the longer it is displayed. This may give the user an experience of the displayed content object 216 gradually fading away.

Displaying a comparatively longer or even the full URL address 216 when navigating or browsing web pages using shortened URL addresses 200 has an advantage that the user interacting with the apparatus 100 can inform himself/herself about the underlying full URL address 216 before making the decision to click (touch) the shortened URL 200 to follow, and thereby navigate to, the webpage associated with the shortened URL 200. It is not uncommon that URL shortening is used to disguise the underlying full URL address. Although this may be desired for legitimate business or personal reasons, it is open to abuse. Embodiments of the present invention may remedy or at least partly overcome such potential abuse, as the user will be able to check the underlying URL address 216 before clicking (e.g. touching) the shortened URL address 200. Embodiments of the present invention thus provide for a simplified and convenient, yet effective, interaction with touch screen apparatuses 100 when navigating, or browsing, web pages.

FIGS. 3A-3F illustrate a series of touch interactions with a content object 200 that may be displayed by a touch screen display 110 of apparatus 100 according to another example embodiment of the invention. This example is essentially similar to the above example described in connection with FIGS. 2A-2F. Therefore, in order to facilitate the reading, all details will not be repeated with reference to FIG. 3. In the example illustrated in FIGS. 3A-3F, the content object is a Quick Response, QR, code. As is well-known, QR codes are a type of matrix barcode consisting of black modules arranged in square pattern on a white background. QR codes may store or otherwise embed, or encoded, Uniform Resource Locator (URL) addresses.

Referring now to FIG. 3B, a user has provided a non-trigger touch interaction by sliding an input object such as a finger along a path 304 from a point of origin 302 to a point 306 within the active region of the touch screen display 110. Optionally, a cursor 308 may be located at a present cursor location as determined by a location at which the input object is contacting the touch screen display 110. In FIG. 2B, the cursor 308 is displayed at the point 306, as the input object is still in contact with the touch screen display 110 at this point 306.

As can be seen in FIG. 3C, the user may provide a further non-trigger touch interaction comprising moving the input object along path 310 to the point 312, which is within the content object 300 (i.e. in this example the QR code) displayed on the touch screen display 110. This non-trigger touch interaction can be indentified as comprising an interaction at the point 312 overlying the QR code 300. Or said differently, the non-trigger touch interaction can be identified as comprising a hovering interaction over the QR code.

In response to the non-trigger touch interaction comprising a hover interaction over the QR code, the URL address 316 associated with QR code 300 can be displayed on the touch screen display 110. This typically involves displaying the URL address 316, which is encoded in the QR code. The URL address 316 is the full or complete URL address associated with the QR code 300. In some embodiments, the URL address 316 associated with the QR code 300 is displayed during a time length, which coincides with the time length during which it is identified that the non-trigger touch interaction comprises the hovering interaction. In other words, as long as the user moves or hovers over the area 314, the URL address 316 will appear as a displayed content object on the touch screen display 110. Accordingly, the time length during which the URL address 316 is displayed is made dependent on the user's hovering interaction over the QR code 300. In other embodiments, the URL address 316 associated with the displayed QR code 300 is displayed during a pre-defined time length. The predefined time length may be pre-set by a timer of timer function of the apparatus 100, similar to the example shown in connection with FIGS. 2A-2F. In a preferred embodiment, the time length may be pre-set to be 15 seconds. However, it will be appreciated that other time lengths are equally possible, such as 1, 2, 5, 10, 20, 30, 60 or 90 seconds. The exact time length can thus be pre-set to match different preferences of different users.

Displaying an URL address 316 when navigating or browsing web pages using QR codes has an advantage that the user interacting with the apparatus 100 can inform himself/herself about the underlying URL address 316 encoded in a QR code before making the decision to perform a trigger touch interaction and, thereby, click (touch) the QR code 300 to follow, and thereby navigate to, the webpage associated with the QR code 300. Embodiments of the present invention thus provide for a simplified and convenient, yet effective, interaction with touch screen apparatuses 100 when navigating, or browsing, web pages using QR codes.

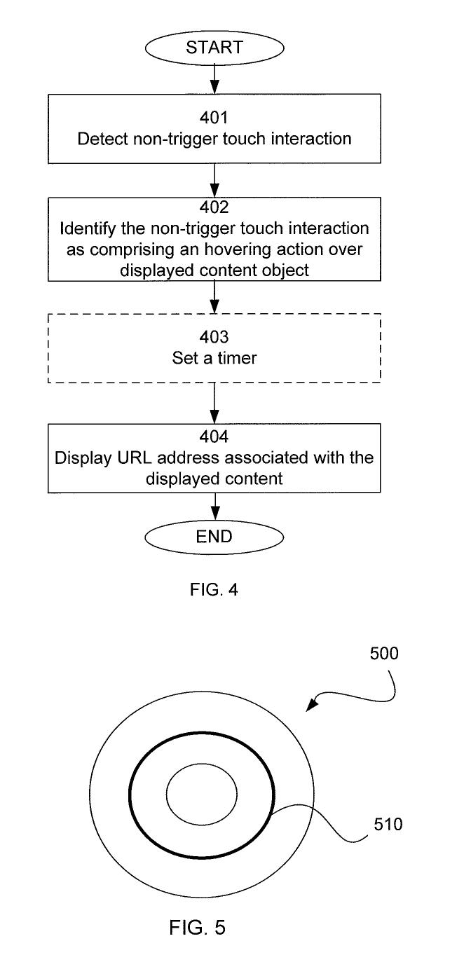

FIG. 4 is a flow chart illustrating a method according to one embodiment executed in an apparatus 100, such as a portable electronic device. In a non-trigger touch interaction detection step 401, a non-trigger touch interaction is detected. In a subsequent hovering identification step 402, the method continues to identify a non-trigger touch interaction as comprising a hovering interaction over a content object (e.g. a shortened URL or a QR code) displayed on the touch screen display of the apparatus. The content object is associated with a uniform resource locator, URL, address. In response to the identification of the non-trigger touch interaction as comprising the hovering interaction over the content object, the method further comprises a display step 404, where the URL address associated with the displayed content object is displayed. In some embodiments, the display step 404 comprises displaying the URL address associated with the displayed content object during a time length, which coincides with the time length during which it is identified that the non-trigger touch interaction comprises the hovering interaction. In other embodiments, the display step comprises displaying the URL address associated with the displayed content object during a time length, which is pre-set. If the URL address is displayed during a pre-set time length, the method may optionally comprise the additional timer setting step 403, where a timer or timer function is set. In one embodiment, the time length is pre-set to be 15 seconds. However, it will be appreciated that other time lengths are equally possible, such as 1, 2, 5, 10, 20, 30, 60 or 90 seconds. The exact time length can thus be pre-set to match different preferences of different users.

FIG. 5 schematically shows one example of a computer program product 50 comprising computer readable means 51. On this computer readable means 51, a computer program can be stored, which computer program, when run on the processor 120 of the apparatus 100, can cause the apparatus 100 to execute the method according to various embodiments described in the present disclosure. In this illustrative example, the computer program product is an optical disc, such as a CD (compact disc), a DVD (digital versatile disc) or a blue-ray. However, in preferred embodiments the computer-readable means can also be solid state memory, such as flash memory or a software package (also sometimes referred to as software application, application or app) distributed over a network, such as the Internet.

The herein disclosed embodiments of the present invention provide for facilitated interaction with apparatuses having touch screen displays. By displaying the URL address of a displayed content object, while or when moving or hovering over the displayed content object, a user interacting with the apparatus will be informed about the underlying URL address of the content object before making a decision to follow, i.e. performing a trigger touch interaction such as clicking (touching) the content object. Various aspects and embodiments of the present invention consequently allow for facilitated, user-intuitive and yet effective navigation or browsing of web pages on apparatuses having touch screen displays.

Although the present invention has been described above with reference to specific embodiments, it is not intended to be limited to the specific form set forth herein. Rather, the invention is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Reference signs in the claims are provided merely as a clarifying example and should not be construed as limiting the scope of the claims in any way.

1-14. (canceled)

15. An apparatus, comprising:
a touch screen display configured to display a content object, the content object being associated with a uniform resource locator, URL, address;
a proximity sensing means;
a processor; and
a memory storing a computer program comprising computer program code which, when run in the processor, causes the apparatus to:
detect, using the proximity sensing means, a non-trigger touch interaction within proximity of the touch screen display;
identify the non-trigger touch interaction as being a hovering interaction over a content object displayed on the touch screen display; and in response thereto
display the URL address associated with the displayed content object.

16. The apparatus according to claim 15, wherein the memory and the computer program code are configured to, with the processor, further cause the apparatus to:
display the URL address associated with the displayed content object during a time length, which coincides with the time length during which it is identified that the non-trigger touch interaction is the hovering interaction.

17. The apparatus according to claim 15, wherein the memory and the computer program code are configured to, with the processor, further cause the apparatus to:
display the URL address associated with the displayed content object during a time length, which is pre-set by a timer.

18. The apparatus according to claim 15, wherein the content object comprises a shortened uniform resource locator, URL, address or a Quick Response, QR, code.

19. The apparatus according to claim 15, wherein the apparatus is a mobile telephone or a tablet computer.

20. A method performed by an apparatus, comprising:
detecting a non-trigger touch interaction within proximity of a touch screen display;
identifying the non-trigger touch interaction as being a hovering interaction over a content object displayed at the touch screen display; wherein content object is associated with a uniform resource locator, URL, address; and
displaying the URL address associated with the displayed content object in response to identifying the non-trigger touch interaction as being the hovering interaction over the content object.

21. The method according to claim 20, wherein the step of displaying comprises:
displaying the URL address associated with the displayed content object during a time length, which coincides with the time length during which it is identified that the non-trigger touch interaction is the hovering interaction.

22. The method according to claim 20, wherein the step of displaying comprises:
displaying the URL address associated with the displayed content object during a time length, which is pre-set.

23. The method according to claim 20, wherein the content object comprises a shortened uniform resource locator, URL, address or a Quick Response, QR, code.

24. A non-transitory computer readable medium storing a computer program comprising computer program code which, when run in a processor of an apparatus, causes the apparatus to:
detect a non-trigger touch interaction within proximity of a touch screen display of the apparatus;
identify the non-trigger touch interaction as being a hovering interaction over a content object displayed at the touch screen display; and in response thereto
display the URL address associated with the displayed content object.

25. The non-transitory computer readable medium according to claim 24, wherein the computer program further comprises computer program code which, when run in the processor of an apparatus, further causes the apparatus to:
display the URL address associated with the displayed content object during a time length, which coincides with the time length during which it is identified that the non-trigger touch interaction is the hovering interaction.

26. The non-transitory computer readable medium according to claim 24, wherein the computer program further comprises computer program code which, when run in the processor of an apparatus, further causes the apparatus to:
display the URL address associated with the displayed content object during a time length, which is pre-set.

27. The non-transitory computer readable medium according to claim 24, wherein the content object comprises a shortened uniform resource locator, URL, address or a Quick Response, QR, code.
